(19) United States
(12) Patent Application Publication
(10) Pub. No.: US 2025/0078142 A1
(43) Pub. Date: Mar. 6, 2025

(54) SYSTEMS AND METHODS OF CUSTOM PRINTING IN CUSTOM PACKAGING FABRICATION

(71) Applicant: Walmart Apollo, LLC, Bentonville, AR (US)

(72) Inventors: Paul Arthur, Bentonville, AR (US); Jeremy M. Bowman, Pinckney, MI (US); Nathan J. Messick, Bella Vista, AR (US)

(21) Appl. No.: 18/806,310

(22) Filed: Aug. 15, 2024

Related U.S. Application Data
(60) Provisional application No. 63/535,792, filed on Aug. 31, 2023.

(51) Int. Cl. G06Q 30/0601; G06Q 30/0251

(52) U.S. Cl. CPC G06Q 30/0635; G06Q 30/0261

(57) ABSTRACT

Some embodiments provide retail order packing control systems comprising: an order fulfillment control system; and a custom package fabrication system comprising a custom printing system. The package fabrication system comprises a package customization control circuit configured to: identify a customer order associated with a customer; confirm that the customer order is eligible to include custom package printing; identify that packaging is to be custom printed for the customer order; identify a package fabrication pattern in fabricating a package specific to the order; identify a print plan, of multiple different print plans, to be applied to the packaging based on the customer and dependent on the package fabrication pattern; and control the custom printing system, of the custom package fabrication system, to print the first print plan onto packaging material to provide custom printed packaging material specific to the first customer order.

### CROSS-REFERENCE TO RELATED APPLICATIONS

This application claims the benefit of U.S. Provisional Application No. 63/535,792 filed Aug. 31, 2023, which is incorporated herein by reference in its entirety.

### TECHNICAL FIELD

This invention relates generally to product transport and fulfillment systems.

### BACKGROUND

Retail customer orders are often fulfilled at one or more fulfillment facilities. Fulfilling product orders can be costly. It is desirable to improve order fulfillment.

### BRIEF DESCRIPTION OF DRAWINGS

Disclosed herein are embodiments of systems, apparatuses and methods pertaining to customizing packaging in fulfilling product orders. This description includes drawings, wherein:

FIG. 1 illustrates a simplified block diagram of an exemplary order packing control system, in accordance with some embodiments.

FIG. 2 illustrates a simplified block diagram of an exemplary custom package fabrication (CPF) system, in accordance with some embodiments.

FIG. 3 illustrates a simplified flow diagram of an exemplary custom package print and fabrication process to control on-demand, custom package fabrication with custom on-demand printing of retail product orders, in accordance with some embodiments.

FIG. 4A illustrates an exemplary customized package that includes a custom printing of an exemplary retailer print campaign, in accordance with some embodiments.

FIGS. 4B-4C illustrate an exemplary customized package that includes an exemplary custom printing of an exemplary print campaign, in accordance with some embodiments.

FIG. 5 illustrates a simplified flow diagram of an exemplary process of custom printing on fabricated packaging, in accordance with some embodiments.

FIG. 6 illustrates a simplified flow diagram of an exemplary custom print process, in accordance with some embodiments.

FIG. 7 illustrates a simplified functional diagram of an exemplary order packing control system, in accordance with some embodiments.

FIG. 8 illustrates an exemplary system for use in implementing methods, techniques, devices, apparatuses, systems, servers, sources and providing on-demand custom printing in custom package fabrication, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Some current embodiments provide enhanced customized, on-demand package fabrication to provide customized imaging, content and/or other such printing on one or more exterior and/or interior surfaces of custom fabricated packages. The packaging of products in fulfilling retail product orders and/or other packaging of items can add significant costs in satisfying orders and/or shipping items. Some retail fulfillment systems provide customized package fabrication specific to one or more particular products and/or a product order. Such customized package fabrication can, in some instances, reduce the amount of product packaging materials used, reduce packaging costs, improve product protections, provide other such benefits, or provide a combination of two or more or all of such benefits.

Such customized, on-demand printing as part of a customized package fabrication process provides added value, enhanced customer satisfaction, enhanced product source satisfaction, improve package routing, improve package handling, improve item safety, and/or other such benefits. Some embodiments can use customer and/or product information to select and/or design a personalized on-demand packaging for one or more items to be placed into the fabricated packaging. Enormous amounts of retail data can be leveraged to identify relevant and current content that can be printed on-demand to provide meaningful branded packaging (e.g., boxes, envelopes, bags, cartons, tubes, etc.). Such printing can be customer requested, based on advertising campaigns, based on historic purchases, based on customer membership and/or status, based on one or more items being purchased, based on purchase history or histories, other such factors, or a combination of two or more of such factors.

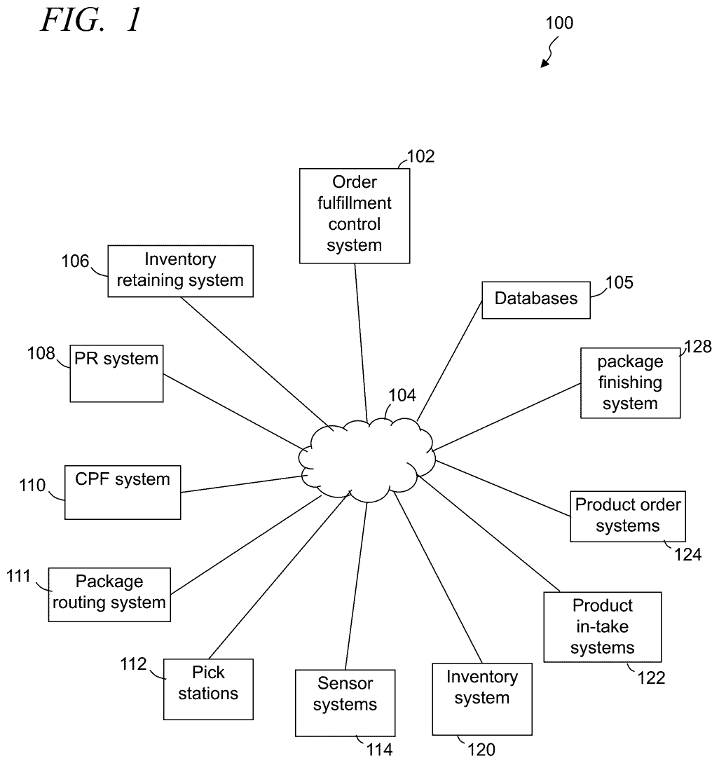

FIG. 1 illustrates a simplified block diagram of an exemplary order packing control system 100, in accordance with some embodiments. The one or more order fulfillment control systems 102 are typically communicatively coupled with one or more distributed wired and/or wireless communication networks 104. The computer and/or communication networks can include substantially any relevant communication such as but not limited to local area network (LAN), wide area network (WAN), the Internet, cellular network, Wi-Fi network, BLUETOOTH network, other such communication networks or a combination of two or more of such wired and/or wireless communication networks. The one or more order fulfillment control systems 102, in some embodiments, is/are implemented through one or more processors, computers, servers and/or other such computing systems that are communicatively coupled over one or more of the distributed communication networks 104 and/or other distributed networks. Further, the one or more order fulfillment control processors, computers, servers and/or other such computing systems of the one or more order fulfillment control systems 102 can be geographically distributed over one or more geographic areas and configured to cooperatively operate to provide redundancy, distributed processing, compensate for potential failures at one or more locations and/or geographic areas, provide distributed computational processing and/or computer memory and/or storage to enhance access speed and/or reliability, and other such benefits.

Some embodiments include one or more databases 105 that store relevant information and are accessible to one or more of the systems of the order packing control system 100 and/or other systems. The databases can store customer information and/or profiles, order information, inventory information, product information and/or profiles, location information, status information, log information, historic shipping information, other such information, and typically a combination of two or more of such information. Further, the databases can be implemented through one or more memories, computers, servers and/or other systems that can be geographically distributed and communicatively coupled with the communication network 104. The distribution can enhance the operation of the system in part by providing redundancy, protection, improved access, and/or other such benefits.

In some embodiments, the order packing control system 100 includes or is cooperatively operated with one or more inventory retaining systems 106 that are configured to receive and store inventory used to fill orders for products from customers, which can include individuals, businesses, other retail facilities of a retailer, other retailers, and/or other such entities ordering products to be delivered and/or picked up. The inventory retaining system 106 can include shelves, racks, receptacles, floor space, bins, refrigeration systems, heating and/or cooking systems, compartments, lockers, and/or other such devices that can receive and store products. Further, in some embodiments, the inventory retaining systems 106 can include one or more processors, computers, servers, sensor and/or other systems that track inventory, track levels of inventory, track occupied space in the one or more inventory retaining systems 106, track unoccupied space in the one or more inventory retaining systems 106, track locations of inventory items, racks, shelves, lockers and other components of the inventory retaining system 106, other such functionality or a combination of two or more of such functionality.

The order packing control system 100, in some embodiments, can include and/or is cooperatively operated with one or more automated product retrieval (PR) systems 108 that are each configured to retrieve one or more products from the one or more inventory retaining systems 106 of orders being received over time. In some instances and/or for some products, the PR system autonomously retrieves one or more products. In other instances and/or for some products the PR system and/or the order fulfillment control system issue commands to utilize other systems and/or methods of retrieval, which can include notifying one or more workers to retrieve one or more products. The product retrieval systems 108 can, in some embodiments, further place products into and/or return products to one or more of the inventory retaining systems (e.g., as part of an ingest and/or decanting process). In some embodiments, one or more of the product retrieval systems 108 include one or more forklifts, one or more pallet carts, hoists, one or more carts, one or more robotic devices, one or more drones, one or more cranes, one or more manipulator arms, one or more conveyors (e.g., belts, rollers, rails, tracks, etc.), other such systems, or a combination of two or more of such systems.

In some embodiments, the one or more product retrieval systems 108 can include one or more processors, computers, servers, sensor and/or other systems (e.g., processors and/or computers of drones, vehicles, robotic systems, etc.) that provide, in part, operational functionality to such systems and enable communication to and/or from these systems. Further, some embodiments incorporate automated and/or partially automated systems that utilize unmanned vehicles, robots, conveyors, etc. to retrieve products, containers, bins and/or totes of one or more products, and/or other systems of storing products and/or transport products through one or more portions of a facility. Additionally or alternatively, the product retrieval system 108 can utilize human workers to retrieve some or all of the products, and/or to route and/or move products through the facility to intended locations (e.g., pick station, storage location, loading area, etc.). Some embodiments incorporate some or all of the storage and retrieval systems, vehicles, methods and/or processes described in U.S. Pat. Nos. 9,39,363, 10,435,241, 10,769,587, 11,179,845, 11,192,719, 11,623,342, and U.S. Patent Application Publication Nos. 2019/0333006, 2022/0281685, 2023/0053089, and 2023/0230031, each of which is incorporated herein by reference in its entirety.

In some embodiments, the order packing control system 100 further includes one or more automated custom package fabrication (CPF) systems 110, which may be partially implemented within the order fulfillment control system 102 or separate from and in communication with the order fulfillment control system 102. The custom package fabrication system can be configured to fabricate on demand custom packages according to custom sizing as a function of one or more products intended to be included into the package being fabricated. Typically, the custom package fabrication systems 110 are communicatively coupled over the one or more of the communication networks 104 with the order fulfillment control system 102. The custom package fabrication systems 110, in some embodiments, utilize dimensions of the one or more products as part of factors in determine a size, shape, volume, material and/or other factors used in fabricating one or more customized packaging (e.g., box, bag, carton, envelope, platform, tube, etc.) specific for the one or more products of the specific order to be packaged within the custom fabricated package. One or more algorithms, processes, machine learning systems and/or other such methods can be employed in determining a size, shape, interior volume, type of packaging material, type and/or amount of protection material(s), and/or other such factors in designing and fabricating the customer package. In some embodiments, for example, the custom package fabrication system 110 applies a cubing algorithm, which considers the dimensions of the one or more products in addition to one or more other order characteristics to define the dimensions of a customized packaging. The characteristics can include, but are not limited to one or more of: types of products, frangibility, predicted mode(s) of transport, temperature restrictions and/or requirements, predicted protective packaging type(s) and/or quantities, duration of transport to destination, type of material used in fabrication, other such characteristics or a combination of such characteristics. In some implementation, the cubing, determining of product arrangement, determination of product dimensions and/or determination of custom package dimensions, materials, and other such characteristics can be partially or fully implemented in accordance with the systems, methods and processes described in U.S. patent application Ser. No. 17/308,689, entitled SYSTEMS AND METHODS FOR ASSEMBLING UNPACKED MERCHANDISE IN CONTAINERS, which is incorporated herein by reference in its entirety. One or more custom package fabrication systems 110 can be incorporated by and/or include some or all of the systems described in U.S. Provisional Application Publication No. 63/346,548, entitled SYSTEMS AND METHODS OF CONTROLLING THE LOADING OF PACKAGES IN FULFILLING ORDERS, which is incorporated herein by reference in its entirety.

In some embodiments, the order packing control system 100 can include a package routing system 111 that is part of and/or cooperated with the custom package fabrication system 110. The package routing system 111 receives custom fabricated packages and/or pre-fabricated packages (e.g., boxes, bags, cartons, envelopes, platforms, tubes, etc.) and routes those packages to assigned pick stations 112 that are intended to utilize the packages in fulfilling at least a part of a product order that is associated with the particular package. Packages can be custom fabricated or pre-fabricated packages can be specifically retrieved for particular orders based on one or more factors. Accordingly, a package can be associated with a particular order and the order fulfillment control system 102 can control the retrieval and routing of the package corresponding to the particular order and the products for the particular order to the same pick station.

One or more sets of sensor systems 114 are typically further included in the order packing control system 100, such as in and/or cooperated with one or more of the order fulfillment control system 102, the product retrieval system 108, inventory retaining system 106, custom package fabrication systems 110, package routing systems 111 and/or other such systems. These sensor systems 114 can be configured to detect and/or sensor data used to track over time positions of packages (e.g., customer and/or prefabricated boxes, customer and/or prefabricated bags, customer and/or prefabricated wrappings, customer and/or prefabricated flexible cartons, bins, totes, and/or other such packaging), products as they are transported to and from the pick stations, received at the facility, decanted, routed to the inventory retaining system, routing to loading stations, loaded into transport vehicles, routed to customer staging areas, picked up, and/or other such movement, robots, workers and/or other systems and/or aspects of the product fulfillment system. Similarly, in some embodiments some of the sensor systems can be configured to further detect and/or be used to track over time locations, status, states of operation and/or other such factors associated with drones, robotic systems, vehicles, conveyors, and/or other such systems of the order packing control system 100 and/or systems cooperatively operating with the order packing control system. The sensor systems can include one or more motion sensing systems, identifying readers (e.g., bar code readers, QR code readers, RF identifying (RFID) tag detectors), cameras, image processing systems, weight sensor systems, accelerometers, gyroscopes, other such senor systems, or a combination of two or more of such sensor systems. The foregoing examples are intended to be illustrative and are not intended to convey an exhaustive listing of all possible sensor systems. Instead, it will be understood that these teachings will accommodate sensing any of a wide variety of circumstances in a given application setting. Further, some embodiments utilize sensor systems of other systems, such as sensor systems of the inventory retaining systems 106, the product retrieval systems 108, the custom package fabrication systems 110, the pick stations 112, the inventory systems 120, the product in-take systems 122, the product order systems 124, drones and/or automated vehicles, sensor systems of vehicles, systems carried and/or transported by workers and/or customers, and other such systems.

In some embodiments, the order packing control system 100 further includes and/or communicatively couples with one or more inventory systems 120 that are configured to track and maintain inventory information about products in the inventory retaining system 106, one or more facilities in which the packing control system is associated and/or track and maintain inventory information about inventory at other facilities, in transit and/or other such inventory information. The inventory system 120, in some implementations, can be implemented through one or more processors, servers, computers and/or other such systems that communicatively couple and cooperate over one or more of the distributed communication networks 104. The inventory system 120 can supply inventory information that can be used to identify particular products, totes, bins and the like to be retrieved, locations of where particular products are located, product quantity information, other such inventory information, and typically a combination of two or more of such inventory information.

In some embodiments, the order packing control system 100 includes and/or cooperates with one or more product in-take systems 122 that process products received at a facility and prepares the products for distribution to the pick stations 112, a retail store, etc. As such, the order packing control system 100 can include and/or cooperatively operate with in-take transport systems (e.g., conveyor systems, vehicles, drones, robotic devices, etc.) that are used to move products from one or more shipping and/or receiving areas of the facility to storage locations awaiting to be retrieved by the product retrieval systems 108. In some implementations, one or more products can be separated out into individual eaches or items (e.g., from a case of the items). Further, some products may be temporarily stored in containers, bins, totes or the like for storage. Still further, in some instances, different types of products can be stored in a single container, while in other instances products might not be mixed. The in-take systems 122 typically communicate with the inventory system 120 to maintain accurate inventory information as products are received, decanted and stored. Further, in some embodiments, the sensor systems 114 include sensor systems that detect states, conditions, positions and/or movement of products, the transport systems and/or other components of the in-take systems. In some embodiments, some or all of the in-take transport systems may be part of the product retrieval systems 108 and/or be used in both in-take as well as transport to pick stations 112, to load stations or areas in preparation for loading into vehicles, to customer staging areas in preparation for customers receiving products from the facility, and/or other such movement.

The order packaging control system 100 can further include and/or is in communication with one or more product ordering systems 124 that are configured to receive orders for one or more products from customers, other retail facilities, other retailers and/or other such individuals and/or entities requesting products. The product ordering system 124, in some embodiments, is implemented through one or more processors, computers, servers and/or other such computing systems that are communicatively coupled over one or more of the distributed communication networks 104 and/or other distributed networks. In some embodiments, the order packaging control system 100 includes one or more package finishing systems 128. Outbound loaded packages containing one or more products for an order can be conveyed from the pick stations 112 to the package finishing system 128 to receive protective packaging and/or dunnage, sealed and in some instances labeling applied (e.g., printed, sticker, etc.).

One or more of the on-demand custom package fabrication systems 110 can operate on demand in real time based on a determined package dimensions to fabricate a customer package consistent with a package fabrication plan determined based on dimensions of one or more items to be placed into the fabricated package and/or other materials to be placed in the package (e.g., item protection materials, order inventory, insulation, etc.). The custom package fabrication system can communicatively coupled with the order fulfillment control system, typically includes one or more package customization control circuits, which can be implemented through one or more processors executing software, microprocessors, ASICs, control logic, other such systems, or a combination of two or more of such systems.

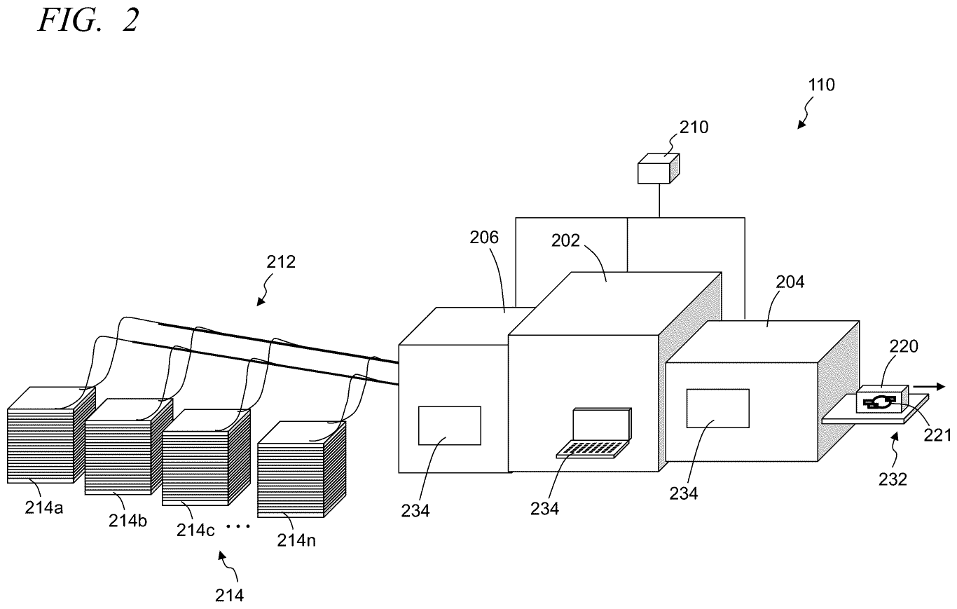

FIG. 2 illustrates a simplified block diagram of an exemplary custom package fabrication system 110, in accordance with some embodiments. The custom package fabrication system 110 can include one or more custom printing systems 202 coupled with a custom fabrication assembly system 204. In some instances, the custom package fabrication system 110 typically further includes one or more pre-fabrication systems 206. The custom package fabrication system 110 can include and/or be in communication with one or more package customization control circuits 210, which can be partially or fully implemented within the order fulfillment control system 102, separate from and in communication with the order fulfillment control system 102, and/or external to or incorporated into one or more of the custom printing system 202, custom fabrication assembly system 204 and/or the pre-fabrication system 206.

The custom package fabrication system 110 is coupled and cooperated with one or more source material feeds 212 that supply one or more packaging source materials 214 (e.g., 214a-214n), which may be supplied one at a time or multiple at a time to the custom package fabrication system 110. The source materials could include one or more kinds of cardboard, corrugate, one or more kinds of paper, one or more kinds of packing and/or protection materials (bubble wrap, tissue paper, foam sheet, etc.), one or more types of insulation, other such source packaging materials, or a combination of two or more of such types of source packaging materials. For example, the source packaging materials 214 may include four different sized, thickness and/or colored cardboards. As a further example, one of the cardboard source packaging materials may have at least one a white surface intended to be an exterior of subsequently fabricated packaging. In some embodiments, a source material can include a white cardboard used with printing.

In some embodiments, the custom package fabrication system 110 can produce fabricated packaging 220 with custom printing 221. The custom printed packaging can in some embodiments be supplied to a packing system and/or sealing system downstream. In some embodiments, the custom fabrication assembly system 204 can include or be coupled with one or more exit package transports 232 that can include one or more conveyor systems, robots, workers and/or other such transport systems that can move packages 220 out of the custom package fabrication system 204. The custom fabrication assembly system 204 may, in some implementations, include or be coupled with one or more product source feeds that can include one or more conveyor systems, robots, workers and/or other such transport systems that can move items into the custom package fabrication system for packing into custom packaging. Further, the custom package fabrication system 110 can optionally include one or more user interfaces 234, which can include one or more displays, one or more user inputs (e.g., keyboard, buttons, mouse, touch pad, touch screen, etc.), enabling one or more users to interface with the custom package fabrication system, control the custom package fabrication system, receive feedback from the custom package fabrication system, and the like. In some implementations, some or all of the user interface 234 can be remote from and communicatively coupled with the custom package fabrication system, and/or the custom package fabrication system can be remotely accessed by user devices (e.g., computer, laptop, smartphone, tablet, etc.).

The packaging customization control circuit (PCCC) 210, in some embodiments, controls the supply of the one or more source packaging materials 214 to the custom package fabrication system 110 based on an intended package to be fabricated. In some implementations, a source packaging material can be directed to the custom printing system 202 that can print, paint and/or otherwise apply in real time a determined print campaign content onto the packaging material to provide custom printed packaging material specific to a customer order. The resulting on-demand custom printed packaging material can be supplied to the custom fabrication assembly system 204 that folds and forms the custom package for one or more items of the customer order. In some embodiments, the source packaging material 214 is supplied to one or more pre-fabrication systems 206 that can pre-process the source packaging material, such as cutting and/or creasing according to a package design, blueprint, plan or the like of the intended final customized packaging to receive one or more items of the particular customer order. In some embodiments, one or more items of inventory from one or more customer orders may be supplied to the custom package fabrication system 110 and packaged within one or more of the on-demand custom fabricated packages 220. Additionally or alternatively, some embodiments transport custom printed packaging to one or more separate downstream packing systems where one or more items and/or additional items may be packaged in one or more custom printed packaging 220 downstream of and separate from a custom package fabrication system 110 as a part of a packing system and/or process. The packing of items into a package, the incorporation of protective materials and/or the closing of the packaging may be automated, partially manual and partially automated, or manually implemented.

The package customization control circuit 210 and/or the order fulfillment control system 102 utilizes extensive retail customer data in identifying content to be printed on to one or more surfaces of the resulting custom fabricated package. Such retail customer data is available through one or more databases 105 (e.g., customer databases, inventory databases, product supplier databases, print campaign databases, etc.) of the retailer that are typically not available outside of the retailer. As such, the use of the extensive retail information enables custom printing that is more relevant to the particular customer and/or is more likely to provide a greater benefit to the customer, the retailer, product advertisers, product manufacturers and/or other entities. The print campaigns are not restricted to retail products, but instead can similarly provide custom information about services, entertainment and/or other such marketing from one or more third parties (e.g., marketing a movie, marketing a concert or concert series, public service announcements, etc.). The extensive retail information can include, but is not limited to purchase history information, location information, regional buying trends information, individual customer data, product information, advertising and marketing information, advertising effectiveness information, inventory data, and/or other such information. Such information can include statistical analysis of such information with algorithms, rules, machine learning and/or other such process of such data can be applied to determine one or more thresholds used in identifying and/or evaluating different print campaigns to identify one or more print campaigns to be printed through one or more on-demand custom printing systems 202. Similarly, some embodiments receive and/or access third party statistical information in identifying print campaigns relative to different customers.

In some embodiments, the package customization control circuit 210 can be configured to identify a customer order that includes one or more items being ordered by a customer of multiple different customers that are each submitting different customer orders. The customer orders, in some implementations, are received through one or more of the product order systems 124, which can include Internet shopping graphical user interfaces, applications (APP) executed on portable computing systems (e.g., smartphones, tablets, etc.), local retail store kiosks, and/or other sources. The order fulfillment system 102 and/or the package customization control circuit 210 can, in some instances, confirm that a particular customer order is or can be eligible for custom package printing. In some instances, one or more customer orders may not be eligible for custom package printing based on one or more factors. For example, some or all of a customer order may be satisfied at one or more fulfillment facilities that do not have the capability to perform custom printing, a particular customer may not qualify for custom printing, one or more products being purchased may preclude custom printing (e.g., based on governmental regulations), other such factors or a combination of two or more of such factors that may disqualify a customer order or part of a customer order from custom printing. For example, in some embodiments, the package customization control circuit 210 in confirming that a customer order is eligible to include custom package printing can identify that a fulfillment facility, of multiple different fulfillment facilities, to be used in fulfilling at least one item of the customer order, and identify that the identified fulfillment facility includes the custom package fabrication system 110 that includes the custom printing system 202 capable of custom printing on the source packaging materials consistent with one or more identified print plans. The fulfillment facilities may include a dedicated fulfillment facility, a retail store, a warehouse, distribution center, and/or other such facilities.

The package customization control circuit 210, in evaluating a particular customer order and when a customer order is eligible, can further identify whether and/or when packaging is to be custom printed for the particular customer order. This evaluation can evaluate the capabilities, printing queue, custom packaging queue, types of one or more products being packaged, whether one or more advertisement campaigns are relevant (e.g., not relevant to an intended customer, not relevant to a product being purchases, not relevant to a receiving location, etc.), other such factors, or a combination of two or more of such factors. This evaluation, in some embodiments, can identify that a particular fulfillment facility is incapable of and/or does not have bandwidth to perform the custom printing, and whether to fulfill some or all of the order at one or more other fulfillment facilities. This determination or a part of this determination may occur as the customer is adding products to a virtual cart. For example, a product order system 124 may obtain a notification of a product being added to a virtual cart and determining whether to offer the customer an option to select and/or specify custom printing (e.g., for a birthday gift, for an anniversary gift, a holiday gift, and the like). Whether to offer the option is typically dependent on one or more factors such as whether a predicted fulfillment facility has packaging print capability, campaigns that may or may not be relevant to a product order (e.g., the customer, an intended recipient, a location, etc.), customer membership level, cost analysis to offer and/or whether fulfillment can be performed at multiple fulfillment facilities, other such factors, or a combination of two or more of such factors.

The package customization control circuit 210 and/or the order fulfillment control systems 102, in identifying a fulfillment facility to satisfy some or all of a customer's order can be configured to identify another fulfillment facility, of the multiple different fulfillment facilities, is a priority fulfillment location for the particular customer order (e.g., is a geographically closest fulfillment facility, is prioritized based on product inventory count, has a greater throughput capability, has a greater throughput history, has greater availability (e.g., available workers, available delivery vehicles, robot availability, inventory, etc.), other such factors, or a combination of two or more of such facility priority factors). It may also be identified that this other fulfillment facility is incapable of providing custom printing. The package customization control circuit 210 and/or the order fulfillment control systems 102 can in some embodiments evaluate the priority relative to the customization printing interests (e.g., customer satisfaction, customer request, marketing incentives, financial costs, etc.). Based on this evaluation the fulfillment facility that has the ability to print may be selected as a substitute fulfillment facility over the other fulfillment facility based at least on the print capable fulfillment facility having the custom printing system. Again, other factors are typically also considered, including such as but not limited to a fulfillment location (e.g., where order is being delivered or picked up), location of the selected fulfillment facility, the selected fulfillment facility having the one or more items of the customer order and/or a prediction that the fulfillment facility will have the one or more items at an estimated time of fulfillment, other such factors, or typically a combination of two or more of such factors.

The package customization control circuit 210 and/or the order fulfillment control systems 102, in some embodiments, evaluate the customer order to confirm whether the order is eligible to include the custom package printing. This evaluation, in some implementations, can include an evaluation of multiple different print campaigns in relation to the customer, and determine or identify that two or more print campaigns, of the multiple different print campaigns, each has a respective predefined campaign threshold relationship with at least one of the customer and one or more items of the order. When two or more campaigns have the threshold relationship, some embodiments can identify that a first print campaign has a priority over a second print campaign. This priority may be based on timing, location, item in an order, other such campaign priority factors, or a combination of two or more of such factors. Some embodiments identify a fulfillment location of the customer order and confirm that the print campaign has a predefined location threshold relationship with the fulfillment location. A purchase history of the customer may be evaluated to confirm that the purchase history has a predefined purchase history threshold relationship with a purchase history restriction of the print campaign. Based on the priority of the first print campaign, the first print plan can be selected and established in accordance with the first print campaign and the first package fabrication pattern.

Some embodiments additionally or alternative confirm that the customer order is eligible to include the custom package printing based on an identification or confirmation that the customer is associated with a customer level authorizing the customer to elect or request to add customized printing. This election can, in some implementations, be presented through a customer user interface. Further, the election may be associated with an added cost. For example, a customer user interface can be controlled to present an option to the customer that can allow the customer to authorize the custom printing. Again, this authorization may include an authorization to pay a fee for the printing. Still further, the customer user interface may present multiple different customized printing plans or patterns from which the customer can choose, provide the customer with one or more fields and/or options to customize the print plan (e.g., select color schemes, incorporate alphanumeric characters, add and/or incorporate graphics, pictures or the like, etc.), enable the customer to identify and/or download one or more images and/or pictures, other such options or a combination of two or more of such options. The customer user interface may further provide an option to authorize payment for cost to implement the customized printing, and based on that input can receive a selection, from the customer, of the print plan and/or one or more options used in defining the print plan.

When custom fabrication is to be performed, the package customization control circuits 210 and/or order fulfillment control systems 102 can identify a particular one or more package fabrication patterns to be applied in fabricating one or more packages specific to the particular customer order to receive the one or more items. In some embodiments, the package customization control circuit 210 and/or order fulfillment control system 102 further utilize dimensions of the one or more products as part of factors in determine a size, shape, volume, material and/or other factors used in defining and/or determining a custom fabrication pattern for one or more customized packaging (e.g., box, bag, carton, envelope, platform, tube, etc.) specific for the one or more products of the specific order to be packaged within the custom fabricated package. One or more fabrication algorithms, processes, machine learning systems and/or other such methods can be employed in determining a size, shape, interior volume, type of packaging material, type and/or amount of protection material(s), and/or other such factors in designing and fabricating the customer package. In some embodiments, for example, the package customization control circuits 210 and/or order fulfillment control systems 102 applies a cubing algorithm, which considers the dimensions of the one or more products in addition to one or more other order characteristics to define the dimensions of a customized packaging. The characteristics can include, but are not limited to one or more of: types of products, frangibility, predicted mode(s) of transport, temperature restrictions and/or requirements, predicted protective packaging type(s) and/or quantities, duration of transport to destination, type of material used in fabrication, other such characteristics or a combination of such characteristics. In some implementation, the cubing, determining of product arrangement, determination of product dimensions and/or determination of custom package dimensions, materials, and other such characteristics can be partially or fully implemented in accordance with the systems, methods and processes described in U.S. patent application Ser. No. 17/308,689, which is incorporated herein by reference in its entirety. In some embodiments the inventory system 120, automated custom package fabrication systems 110, the order fulfillment control system 102 and/or a one or more externally accessible sources maintain one or more product profiles associated with respective products with information about the product, such as but not limited to size, dimensions, weight, type, frangibility, packing instructions and/or restrictions, storage temperature thresholds, shipping temperature thresholds, expiration information, priority information, other such information, and typically a combination of two or more of such factors. In some embodiments, the custom package fabrication system 110 and/or order fulfillment control system 102 execute cartonization logic using at least in part dimensions of the one or more products, and typically additional one or more other order characteristics to define a fabrication packaging pattern, plan, blueprint or the like which can include the type of material, dimensions and the like of the one or more custom packages to be fabricated specifically for the particular order.

When custom printing is to be applied, the package customization control circuit 210 and/or the order fulfillment control system 102 can identify and/or define a respective print plan, or multiple different print plans, to be applied to the packaging based one or more print factors. These print factors can include but are not limited to content of one or more print contents, patterns and/or plans to be applied, limits of such print content, the customer, an intended recipient, the package fabrication pattern (e.g., dimensions, materials, etc.), one or more identified campaigns, customer requested content, other such print factors, or a combination of two or more of such print factors. The final print plan can be a combination of two or more print plans cooperated to be applied to one or more portions of the final fabricated packaging. For example, different print plans can be assigned to different exterior and/or interior surfaces, and print instructions defined to be executed by the custom printing system 202 to apply the printing to one or more surfaces of the one or more packaging source materials 214. One or more print algorithms, processes, machine learning systems and/or other such methods can be employed in determining sizes, shapes, color schemes, inks, toners, temperatures, and the like that define the print plan. The custom printing system 202 of the custom package fabrication system 110 is controlled to receive the one or more packaging source materials 214, which may have been preprocessed (e.g., cut, creased, etc.), and implement the print plan according to the printing instructions to print the identified one or more print plans onto packaging material to provide custom printed packaging material specific to the customer order.

As introduced above, some embodiments define a print plan that incorporates two or more print plans and/or multiple campaigns. The package customization control circuit can be configured, for example, to evaluate multiple different print campaigns in relation to the customer and confirm that two or more different print campaigns, of the multiple different print campaigns, each has a respective predefined campaign threshold relationship with at least one of the customer and one or more items in the order. The print plan can be established dependent on the package fabrication pattern and incorporating each of the two or more print campaigns.

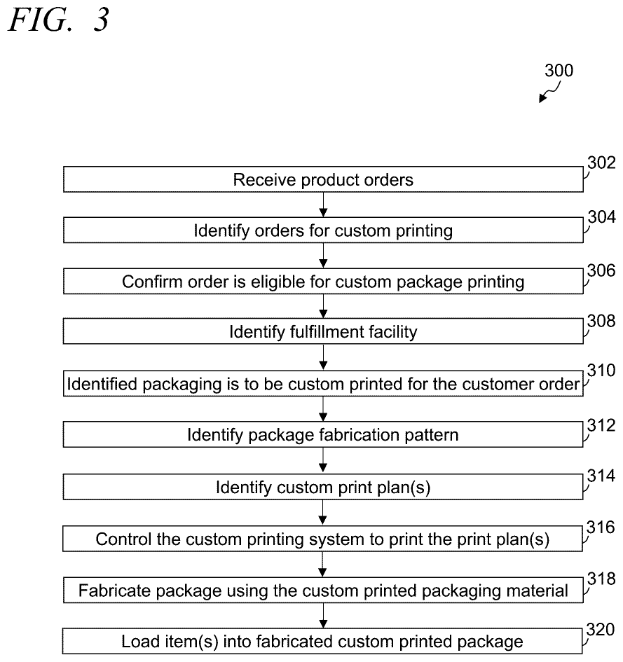

FIG. 3 illustrates a simplified flow diagram of an exemplary custom package print and fabrication process 300 to control on-demand, custom package fabrication with custom on-demand printing of retail product orders, in accordance with some embodiments. In step 302, numerous different product orders are received from multiple different customers. Each order includes an order for at least one item. In step 304, customer orders are identified, of the multiple different product orders, for one or more items associated with a respective customer of the multiple different customers, that may be relevant to custom printing on packaging. In step 306, the orders can be evaluated to confirm that the respective customer order is eligible to include custom package printing. For example, some orders may not be packaged, some orders may be fulfilled at facilities unable to perform custom printing and/or other such factors.

In step 308, a fulfillment facility is identified, of multiple different fulfillment facilities, that is to be used in fulfilling one or more items of the particular order. When custom printing is to be applied, this selection can include identifying that the fulfillment facility includes the custom package fabrication system 110 having the custom printing system 202. Further, the selection of a fulfillment facility can include the distribution across multiple different fulfillment facilities. This can include attempting to balance print demand across different fulfillment facilities of a network of multiple geographically distributed fulfillment facilities. One or more restrictions and/or parameters may apply in balancing print demand, such as distance limits, timing limits, and/or other such factors. As such, a network of fulfillment facilities can cooperatively be operated and controlled to improve the distribution of custom printings on fabricated packaging. Some embodiments may identify that a second fulfillment facility, of the multiple different fulfillment facilities, is a priority fulfillment location of the particular customer order, but further identify that this second fulfillment facility is incapable of providing custom printing. Accordingly, the first fulfillment facility can be selected as a substitute fulfillment facility over the second fulfillment facility based on the first fulfillment facility having the custom printing system 202 and having the at least one item. When multiple fulfillment facilities are evaluated, some embodiments identify a fulfillment location of the first customer order. These multiple fulfillment facilities can be evaluated to confirm which one or more facilities and a second fulfillment facility each has a location threshold relationship with the fulfillment location. Further, some embodiments confirm whether one or more of the identified facilities is predicted to have at least one item at an estimated time of fulfillment. In some embodiments, a cost benefit can be identified of fulfilling the customer order through a first fulfillment facility relative to and/or over fulfillment at a second fulfillment facility. A particular fulfillment facility can be selected, based on the identified cost benefit, to fulfill at least part of the customer order comprising the at least one item.

In step 310, it is identified that packaging is to be custom printed for the customer order. This custom printing can be identified, in some embodiments, based in part on identifying that the customer is associated with a customer level that authorizes the customer to elect to add customized printing. Some embodiments control a customer user interface to present an option to the customer of elect whether to custom print and/or to authorize the custom printing. Some embodiments identify a customer order corresponds to and/or has a threshold relationship with one or more print campaigns.

In step 312, a package fabrication pattern can be identified that can be applied in fabricating a package specific to the particular order into which is to be placed one or more items of the order. The package fabrication pattern can define the size and shape of a package to be fabricated. This can include information dimensions and/or areas of surfaces that may receive printing. In step 314, one or more custom print plans, of multiple different print plans, can be identified that can be applied to the on-demand fabricated packaging based on the customer and dependent on the package fabrication pattern. The determination of the print plan can include, in some embodiments, an evaluation of multiple different print options and/or campaigns in relation to the customer, the order, customer information exclusively corresponding to the customer, such as purchase history, location, and/or other such information.

The print campaigns may be advertisement campaigns, informational information, celebratory information (e.g., birthday, anniversary, etc.), instructional information (e.g., directions and/or use information of an item within the package, package handling information, package disposal information, instructions for reshaping the packaging for a secondary use (e.g., cut-outs and folds to enable use by children (e.g., cardboard car, a dollhouse, etc.), other such instructional information), warning information and/or notifications, other such campaigns, or a combination of two or more of such campaigns. Some embodiments can confirm that a first print campaign, of the multiple different print campaigns, has a predefined campaign threshold relationship with at least one of the first customer, the at least one item to be placed in the package, a location of receiving the item, a location of fulfillment, other such relationships, or a combination of two or more of such relationships. As one non-limiting example, an advertising campaign may be associated with a particular geographic area and with a set of predefined products, and the advertising campaign may be selected to be included in the print plan when the order complies with a threshold distance to the particular geographic area and an ordered item is within or has a threshold relationship with the set of predefined products. The print plan can be established in accordance with the print campaign and the package fabrication pattern. As another non-limiting example, some embodiments identify a fulfillment location of the customer order, confirm that the print campaign has a predefined location threshold relationship with the fulfillment location, and evaluate a purchase history of the customer and confirm that the purchase history has a predefined purchase history threshold relationship with a purchase history restriction of the first print campaign.

In many instances, multiple different print campaigns can be evaluated in relation to the customer and/or the one or more items of the order. It may be confirm that two or more print campaigns, of the multiple different print campaigns, satisfy one or more threshold relationships. For example, a second print campaign may have a secondary predefined campaign threshold relationship with at least one of the customer and one or more items of the order, and the print plan can be established dependent on the determined package fabrication pattern and incorporating both a print campaign and the second print campaign. In other instances, an evaluation of multiple different print campaigns in relation to the customer may result in the identification that a first print campaign and a second print campaign, of the multiple different print campaigns, each has a respective predefined campaign threshold relationship with at least one of the customer and the at least one item. It may be identified, however, that the first print campaign has a priority over the second print campaign, and print plan can be established based on the priority of the first print campaign in accordance with the first print campaign and the package fabrication pattern.

In step 316, the custom printing system 202 of a custom package fabrication system 110 can be controlled to print the print plan onto packaging material to provide custom printed packaging material specific to the customer order. Some embodiments include step 318 where the package, specific to the customer order using, is fabricated on-demand using the custom printed packaging material. In step 320, the one or more items of the order can be placed into the fabricated package, protective materials may be added, the packaging can be sealed or otherwise closed, and when relevant one or more finishings may be applied (e.g., taping, stamps, labels, routing information, and/or other finishings). It will be appreciated by those skilled in the art that one or more of the above steps can be implemented in a different order, repeated one or more times, skipped and/or excluded.

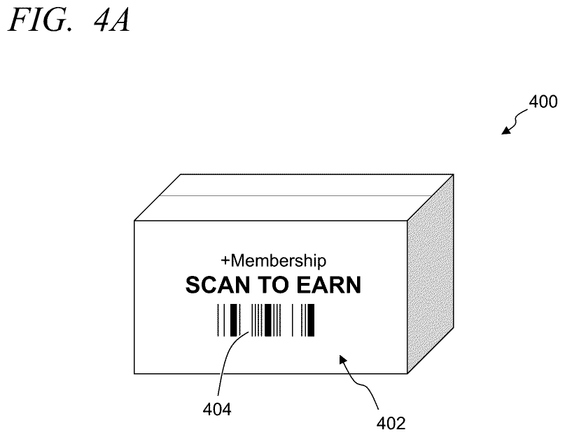

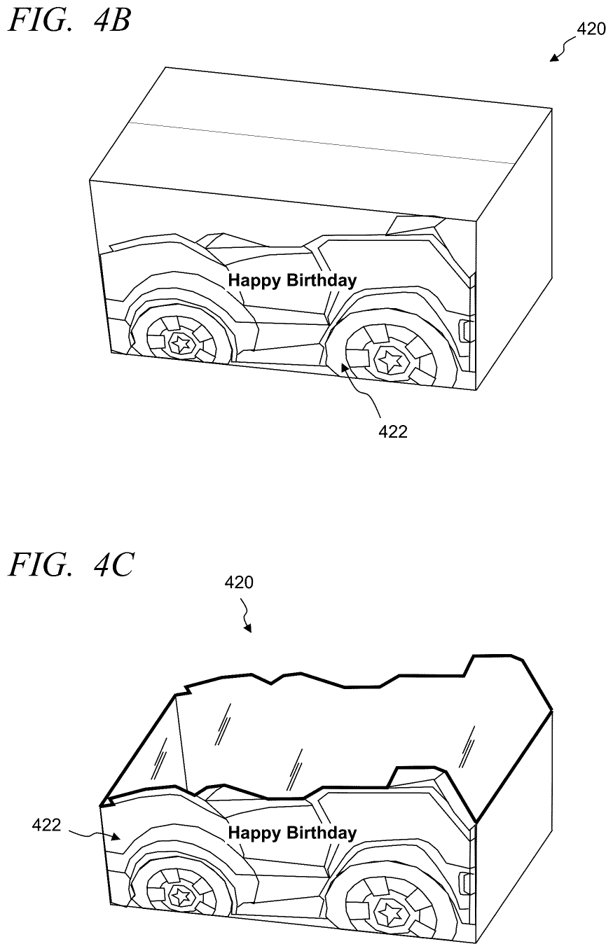

FIG. 4A illustrates an exemplary customized package 400 that includes a custom printing 402 of an exemplary retailer print campaign, in accordance with some embodiments. The exemplary print campaign can, for example, be a promotion to grant a customer with additional benefits when the customer takes action as defined in the printing (e.g., scanning by a customer's mobile device a printed barcode 404 of the print campaign that would direct the customer to a predefined website and/or activate a particular aspect of an APP executed on the customer's device). FIGS. 4B-4C illustrate an exemplary customized package 420 that includes an exemplary custom printing 422 of an exemplary print campaign, in accordance with some embodiments. This exemplary printing 422 can correspond to a celebratory print campaign (e.g., “Happy Birthday”) that includes a printed graphic of a car that may be cut out (see FIG. 4C). The printing 422 may include instructions to cut out portions of the box that would enable a child to sit in the box with the car graphic exposed. Some embodiments may monetize custom printing and/or secondary packaging to provide a retailer with an additional revenue stream to offset the costly fulfillment process.

One or more print campaigns can be applied to a single package. The print campaigns can be provided for various purposes. For example, an advertiser may want to design a print campaign and/or print graphics of a box for people in a specific zip code, advertiser may want a print campaign to be custom printed to the packaging to specific items and/or SKU sets dependent on a movie release, advertiser may want to design a print campaign that compliments orders containing certain merchandise, a retailer may want to design a print campaign specific to customers with differing customer levels and/or values, an advertiser and/or retailer may want to promote multimedia content benefits for customers that have a high interest in television programs, a retailer may utilize a print campaign that promotes benefits (e.g., fuel discounts to customers), print campaigns for gifting and registries, print campaigns to provide customers the ability to print on the exterior of the packaging for celebratory events such as birthdays, holidays, newborn registries, and wedding registries, print campaigns with individualized messaging on the secondary packaging dependent on the order contents and customer information, and other campaigns.

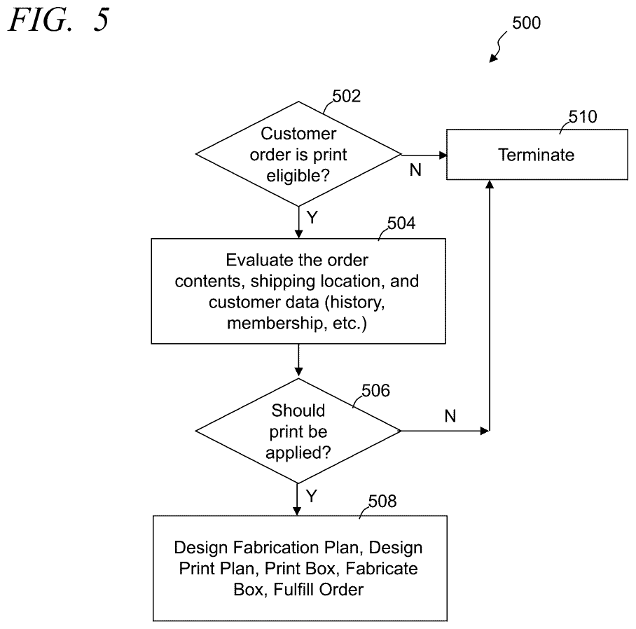

FIG. 5 illustrates a simplified flow diagram of an exemplary process 500 of custom printing on fabricated packaging, in accordance with some embodiments. In step 502, it is determined whether a particular order is eligible for custom printing. One or more factors may be considered in determining printing eligibility, such as but not limited to fulfillment facility, print capabilities, customer and/or other such factors. When an order is not eligible, some embodiments terminate the process in step 510. In step 504, one or more order factors are identified and evaluated. Such order factors can include but is not limited to the item or items in an order, customer information (e.g., purchase history, print history, delivery history, membership information, customer level, etc.), location information (e.g., fulfillment location, shipping location, etc.), other such order information, or a combination of two or more of such order information. In step 506, it can be determined whether custom printing on packaging material is to be applied. Some embodiments determine whether order factors, customer information, item information, and/or other such information satisfy one or more predefined thresholds to determine when one or more print plans are to be applied. When printing is to be applied the process 500 can advance to step 508 where on-demand customer package printing can be implemented on source packaging materials 214, the package fabricated on-demand, and one or more items placed into the custom printed package.

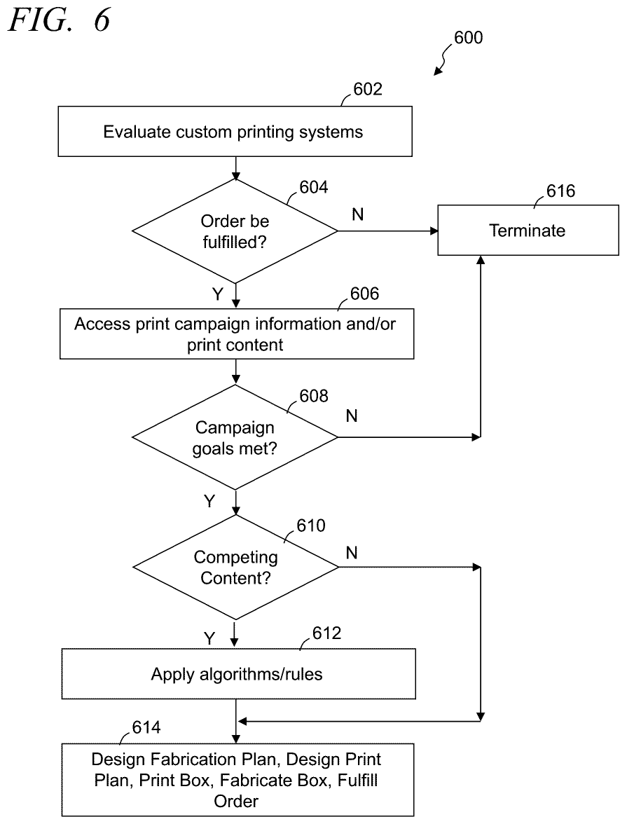

FIG. 6 illustrates a simplified flow diagram of an exemplary custom print process 600, in accordance with some embodiments. In step 602, custom printing systems 202, across an ecommerce network of ordering systems and/or order fulfillment systems associated with one or more fulfillment facilities, are evaluated regarding the potential real-time, on-demand, custom printing on one or more surfaces of source packaging materials 214 to determine whether custom printing is to be utilized and/or offered as an option. When printing cannot be satisfied the process may terminal at step 616. In step 604, it is determined whether custom printing can be satisfied by one or more of the printing systems 202. As introduced above, one or more factors can be evaluated relative to the order, the customer, location information, print campaigns and/or other information. In step 606, one or more databases of print campaigns and/or campaign information is accessed and evaluated relative to one or more factors as described above. In step 608, it is determined whether the print factors comply with and/or met one or more goals and/or thresholds corresponding to one or more print campaigns. Some embodiments include step 610 where it is determined whether two or more print campaigns are satisfied and/or whether there is competing print campaigns. When there is competing campaigns the process can apply one or more algorithms and/or rules in step 612 to determine which of the two or more competing campaigns to apply. This can include looking at timing thresholds, priorities of campaigns, levels of correlations between different campaigns and the customer, customer purchase history information, other such information, or a combination of two or more of such relationships. In step 614 a print plan is defined according to one or more non-competing and/or complimentary print campaigns, and the custom printing system 202 is controlled to print on the source material to provide the printed material used to fabricate the custom package into which one or more products of the customer order are placed.

As described above, one or more print plans may be based on input from the customer and/or modified by the customer, while in other instances a print plan may be based on one or more selected predefined print campaigns, which may be advertising, informational, celebratory, and/or other such campaigns. Still further, the print plan may include print campaigns that provide information for use by the retail entity, delivery entity and/or customer, such as but not limited to notices (e.g., fragile, “This End Up”, medicine, temperature information, warnings, etc.), instructions on delivery (e.g., where to place at a delivery location, special instructions for care, beware of animal, etc.), and/or other such information. It will be appreciated by those skilled in the art that one or more steps of the described processes 300, 500 and 600 can be excluded, repeated one or more times, implemented in different orders and/or other such modifications. Similarly, some or all of the steps of the described processes 300, 500 and 600 may be implemented as part of one or more of the other of the processes 300, 500 and 600. For example, one or more of the steps of processes 500 and 600 may be implemented as part of the custom package print and fabrication process 300.

One or more algorithms, rules and/or machine learning applications can be applied to provide sizing adjustments dependent on dimensions of surfaces of a package according to the package pattern. Simulation tools can be applied to adjust and fine tune the sizing, and provide feedback to improve the algorithms, rules and/or machine learning. This can provide printings onto packaging with greater precision and accuracy.

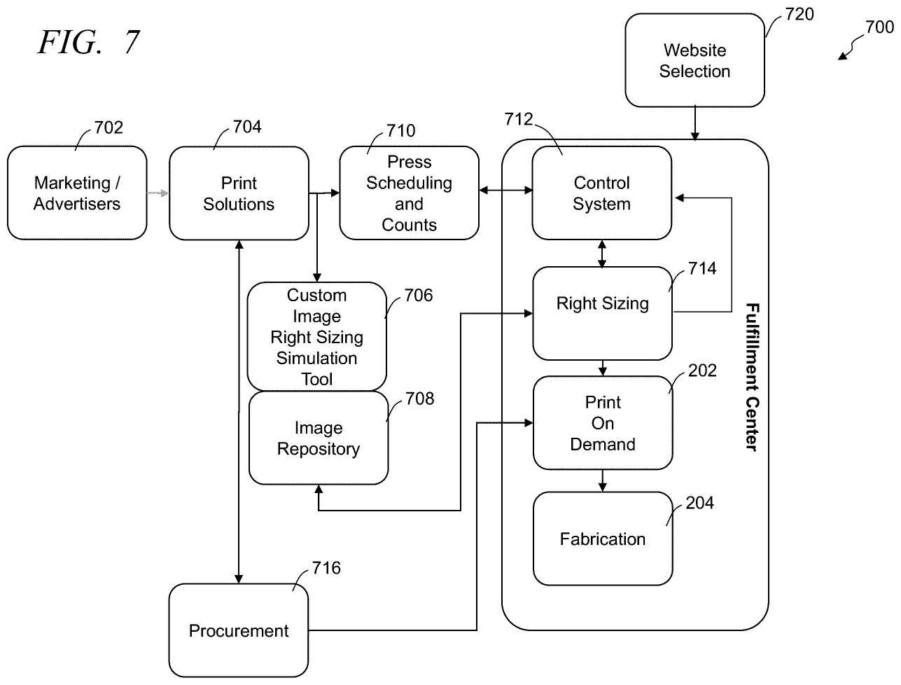

FIG. 7 illustrates a simplified functional diagram of an exemplary order packing control system 700, in accordance with some embodiments. One or more print campaign sources 702 (e.g., product manufacturers, advertisers, retailer, etc.) can provide information to be incorporated into one or more print campaigns. Print solutions 704 can establish the different print campaigns. In some implementations, the print solutions can define a general printing content and a general dimensions for printing. Some embodiments provide a custom image and right sizing simulation tool 706 that uses a packaging pattern and/or dimensions to customize sizing of fonts, imagery, coloring and the like of a particular print solution to accurately scale and print onto the packaging material. Some embodiments include an image repository 708 that stores graphics, print solutions, images and/or other content that are part of or can be incorporated into print campaigns. Some embodiments include a scheduling and/or counts system 710 that tracks the use of the different print campaigns, which can include confirming compliance with contractual obligations, print quantities, time of print campaigns and/or other such factors.

The system in some embodiments includes customer input interface 720 (e.g., through a website, an APP, etc.) that may enable customers to customize print campaigns. A control system 712, such as the package customization control circuits 210, can control the automated custom package fabrication systems 110. In some embodiments, a right sizing system 714 is provided with the custom print and fabrication system 712 that can cooperate with the custom image and right sizing simulation tool 706 to confirm accurate scaling and printing. The system includes the custom printing system 202 that uses the scaled campaign instructions to execute the custom printing on the source materials, which is feed to the custom package fabrication assembly system 204. The system 700 typically further includes a procurement system and/or input 716 that tracks use of materials (e.g., source packaging materials, toner, paint, ink, etc.), which in some instances automatically directs the acquisition and restocking of the materials.

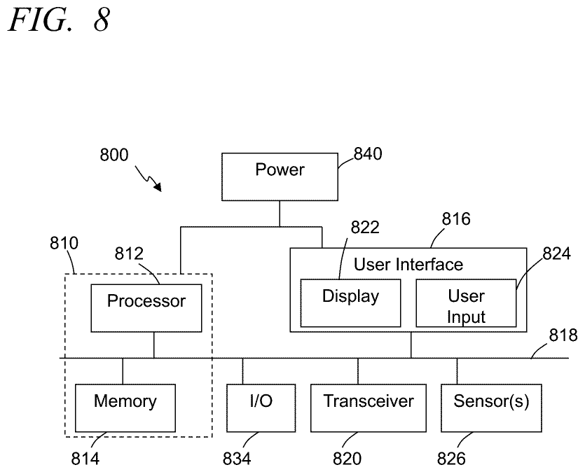

Further, the circuits, circuitry, systems, devices, processes, methods, techniques, functionality, services, servers, sources and the like described herein may be utilized, implemented and/or run on many different types of devices and/or systems. FIG. 8 illustrates an exemplary system 800 that may be used for implementing any of the components, circuits, circuitry, systems, functionality, apparatuses, processes, or devices of the order packing control system 100 of FIG. 1, the custom package fabrication systems 110 of FIG. 2, and/or other above or below mentioned systems or devices, or parts of such circuits, circuitry, functionality, systems, apparatuses, processes, or devices. However, the use of the system 800 or any portion thereof is certainly not required.

By way of example, the system 800 may comprise one or more control circuits or processor modules 812, one or more memory 814, and one or more communication links 818, paths, buses or the like. Some embodiments may include one or more user interfaces 816, and/or one or more internal and/or external power sources or supplies 840. The control circuit 812 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 812 can be part of control circuitry and/or a control system 810, which may be implemented through one or more processors with access to one or more memory 814 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 800 may be used to implement one or more of the above or below, or parts of, components, circuits, systems, processes and the like.

The user interface 816 can allow a user to interact with the system 800 and receive information through the system. In some instances, the user interface 816 includes a display 822 and/or one or more user inputs 824, such as buttons, touch screen, track ball, keyboard, mouse, etc., which can be part of or wired or wirelessly coupled with the system 800. Typically, the system 800 further includes one or more communication interfaces, ports, transceivers 820 and the like allowing the system 800 to communicate over a communication bus, a distributed computer and/or communication networks 104 (e.g., a local area network (LAN), the Internet, wide area network (WAN), etc.), communication link 818, other networks or communication channels with other devices and/or other such communications or combination of two or more of such communication methods. Further the transceiver 820 can be configured for wired, wireless, optical, fiber optical cable, satellite, or other such communication configurations or combinations of two or more of such communications. Some embodiments include one or more input/output (I/O) ports 834 that allow one or more devices to couple with the system 800. The I/O ports can be substantially any relevant port or combinations of ports, such as but not limited to USB, Ethernet, or other such ports. The I/O interface 834 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 826 to provide information to the system and/or sensor information that is communicated to another component, such as the central control system, inventory transport systems, custom package fabrication system 110, inventory retaining system 106, the product retrieval system 108, picking stations 112, and other such systems. The sensors can include substantially any relevant sensor, such as but not limited to optical-based scanning sensors to sense and read optical patterns (e.g., bar codes), radio frequency identification (RFID) tag reader sensors capable of reading RFID tags in proximity to the sensor, distance measurement sensors (e.g., optical units, sound/ultrasound units, etc.), weight sensors, motion sensors, imaging systems, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 800 comprises an example of a control and/or processor-based system with the control circuit 812. Again, the control circuit 812 can be implemented through one or more processors, controllers, central processing units, logic, software and the like. Further, in some implementations the control circuit 812 may provide multiprocessor functionality.

The memory 814, which can be accessed by the control circuit 812, typically includes one or more processor-readable and/or computer-readable media accessed by at least the control circuit 812, and can include volatile and/or nonvolatile media, such as RAM, ROM, EEPROM, flash memory and/or other memory technology. Further, the memory 814 is shown as internal to the control system 810; however, the memory 814 can be internal, external or a combination of internal and external memory. Similarly, some or all of the memory 814 can be internal, external or a combination of internal and external memory of the control circuit 812. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer networks 104. The memory 814 can store code, software, executables, scripts, data, content, lists, programming, programs, log or history data, user information, customer information, product information, and the like. While FIG. 8 illustrates the various components being coupled together via a bus, it is understood that the various components may actually be coupled to the control circuit and/or one or more other components directly.

The custom printing systems 202 implemented in cooperation with and/or as part of a custom package fabrication system 110 allows custom printing to the on-demand custom packaging. Such printing can provide print advertisements on the customized packaging (e.g., boxes, bags, envelopes, etc.) for brands or a customer can customize the inside and/or outside of the packaging. The customization may incorporate birthday, holiday decorations, etc. Some embodiments utilizes the integration of customer and order information to determine what to print upon the packaging, which can use real-time data when the order is being fulfilled. The print systems 202 cooperated with the custom package fabrication incorporated into fulfillment facilities enables greater customization based in part on being closer to the customer. The customized printing enables in part personalization, geolocation relevant print campaigns on-demand, easy and rapid changing of print campaigns, complementary branding based on SKU, customer specific information to target the messaging to a specific customer, increased customer satisfaction, customer controlled customized printing and numerous other such benefits. Further, the networked accessibility of the printing system 202 enables remote management of production of custom package printing to provide autonomous operation of custom printing of on-demand fabricated packaging. Further, the custom printing system 202 enables marketing for internal retailer campaigns (e.g., membership benefits, membership discounts, seasonal marketing, celebratory events, etc.), advertising campaigns with partner suppliers, customer guided custom printing (e.g., gifting for special occasions such as birthdays, holidays, weddings, newborns, etc.), custom printed packaging for third party sellers utilizing multi-channel fulfillment, on-demand print shipping labels and department of transportation hazmat labels, and other such custom printing specifically relevant to the customer and/or order. In some applications, the custom printing system 202 of the package fabrication system provides a retailer with the assets to utilize the extensive customer, product and other such information to design a personalized on-demand box and/or other packaging. The print campaigns can be scaled according to one or more surfaces of the to be completed package as defined by the package pattern to provide a multicolor right sized packaging utilizing customer and product data on any scale (single to mass scale).

In some embodiments, systems and corresponding methods performed by the systems, comprises: an order fulfillment control system; a custom package fabrication (CPF) system communicatively coupled with the order fulfillment control system, wherein the custom package fabrication comprises a custom printing system; wherein the custom package fabrication system comprises a package customization control circuit configured to: identify a first customer order of at least one item associated with a first customer of multiple different customers submitting different customer orders; confirm that the first customer order is eligible to include custom package printing; identify that packaging is to be custom printed for the first customer order; identify a first package fabrication pattern to be applied in fabricating a first package specific to the first customer order to receive the at least one item; identify a first print plan, of multiple different print plans, to be applied to the packaging based on the first customer and dependent on the first package fabrication pattern; and control the custom printing system, of the custom package fabrication system, to print the first print plan onto packaging material to provide custom printed packaging material specific to the first customer order.

Some embodiments provide methods of customizing packaging of retail product orders, comprising: receiving numerous different product orders from multiple different customers; identifying a first customer order, of the multiple different product orders, for at least one item associated with a first customer of the multiple different customers; confirming that the first customer order is eligible to include custom package printing; identifying that packaging is to be custom printed for the first customer order; identifying a first package fabrication pattern to be applied in fabricating a first package specific to the first customer order to receive the at least one item; identifying a first print plan, of multiple different print plans, to be applied to the packaging based on the first customer and dependent on the first package fabrication pattern; and controlling a custom printing system, of a custom package fabrication (CPF) system, to print the first print plan onto packaging material to provide custom printed packaging material specific to the first customer order.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A retail order packing control system, comprising:
an order fulfillment control system; and
a custom package fabrication (CPF) system communicatively coupled with the order fulfillment control system, wherein the custom package fabrication system comprises a custom printing system;
wherein the custom package fabrication system comprises a package customization control circuit configured to:
identify a first customer order of at least one item associated with a first customer of multiple different customers submitting different customer orders;
confirm that the first customer order is eligible to include custom package printing;
identify that packaging is to be custom printed for the first customer order;
identify a first package fabrication pattern to be applied in fabricating a first package specific to the first customer order to receive the at least one item;
identify a first print plan, of multiple different print plans, to be applied to the packaging based on the first customer and dependent on the first package fabrication pattern; and
control the custom printing system, of the custom package fabrication system, to print the first print plan onto packaging material to provide custom printed packaging material specific to the first customer order.

2. The system of claim 1, wherein the package customization control circuit, in confirming that the first customer order is eligible to include the custom package printing, is configured to:
identify a first fulfillment facility, of multiple different fulfillment facilities, to be used in fulfilling the at least one item, and
identify that the first fulfillment facility includes the custom package fabrication system having the custom printing system.

3. The system of claim 2, wherein the package customization control circuit, in the identifying that the packaging is to be custom printed, is configured to:
evaluate multiple different print campaigns in relation to the first customer;
confirm a first print campaign, of the multiple different print campaigns, has a predefined campaign threshold relationship with at least one of the first customer and the at least one item; and
establish the first print plan in accordance with the first print campaign and the first package fabrication pattern.

4. The system of claim 3, wherein the package customization control circuit, in the evaluating the multiple different print campaigns, is configured to:
identify a fulfillment location of the first customer order;
confirm that the first print campaign has a predefined location threshold relationship with the fulfillment location; and
evaluate a purchase history of the first customer and confirm that the purchase history has a predefined purchase history threshold relationship with a purchase history restriction of the first print campaign.

5. The system of claim 3, wherein the package customization control circuit is further configured to:
confirm a second print campaign, of the multiple different print campaigns, has a secondary predefined campaign threshold relationship with at least one of the first customer and the at least one item; and
establish the first print plan dependent on the first package fabrication pattern and incorporating both the first print campaign and the second print campaign.

6. The system of claim 2, wherein the package customization control circuit, in the identifying the first fulfillment facility, is configured to:
identify a second fulfillment facility, of the multiple different fulfillment facilities, is a priority fulfillment location of the first customer order;
identify that the second fulfillment facility is incapable of providing custom printing; and
select the first fulfillment facility as a substitute fulfillment facility over the second fulfillment facility based on the first fulfillment facility having the custom printing system, the fulfillment location and the first fulfillment facility having the at least one item.

7. The system of claim 2, wherein the package customization control circuit, in identifying the first fulfillment facility, is configured to:
identify a fulfillment location of the first customer order;
confirm that the first fulfillment facility and a second fulfillment facility each has a location threshold relationship with the fulfillment location;
confirm that each of the first fulfillment facility and the second fulfillment facility is a predicted to have the at least one item at an estimated time of fulfillment;
identify a cost benefit of fulfilling the first customer order through the first fulfillment facility over fulfillment at the second fulfillment facility; and
select the first fulfillment facility, based on the identified cost benefit, to fulfill at least part of the first customer order comprising the at least one item.

8. The system of claim 1, wherein the package customization control circuit, in confirming that the first customer order is eligible to include the custom package printing, is configured to:
identify that the first customer is associated with a customer level authorizing the first customer to elect to add customized printing; and
control a customer user interface to present an option to the first customer of authorizing the customized printing.

9. The system of claim 1, wherein the package customization control circuit, in confirming that the first customer order is eligible to include the custom package printing, is configured to:
evaluate multiple different print campaigns in relation to the first customer;
identify that a first print campaign and a second print campaign, of the multiple different print campaigns, each has a respective predefined campaign threshold relationship with at least one of the first customer and the at least one item;
identify that the first print campaign has a priority over the second print campaign; and
establish, based on the priority of the first print campaign, the first print plan in accordance with the first print campaign and the first package fabrication pattern.

10. A method of customizing packaging of retail product orders, the method comprising:
receiving multiple different product orders from multiple different customers;
identifying a first customer order, of the multiple different product orders, for at least one item associated with a first customer of the multiple different customers;
confirming that the first customer order is eligible to include custom package printing;
identifying that packaging is to be custom printed for the first customer order;
identifying a first package fabrication pattern to be applied in fabricating a first package specific to the first customer order to receive the at least one item;
identifying a first print plan, of multiple different print plans, to be applied to the packaging based on the first customer and dependent on the first package fabrication pattern; and
controlling a custom printing system, of a custom package fabrication system, to print the first print plan onto packaging material to provide custom printed packaging material specific to the first customer order.

11. The method of claim 10, wherein the confirming that the first customer order is eligible to include the custom package printing comprises:
identifying a first fulfillment facility, of multiple different fulfillment facilities, to be used in fulfilling the at least one item; and
identifying that the first fulfillment facility includes the custom package fabrication system having the custom printing system.

12. The method of claim 11, wherein the identifying that the packaging is to be custom printed comprises:
evaluating multiple different print campaigns in relation to the first customer;
confirming a first print campaign, of the multiple different print campaigns, has a predefined campaign threshold relationship with at least one of the first customer and the at least one item; and
establishing the first print plan in accordance with the first print campaign and the first package fabrication pattern.

13. The method of claim 12, wherein the evaluating the multiple different print campaigns comprises:
identifying a fulfillment location of the first customer order;
confirming that the first print campaign has a predefined location threshold relationship with the fulfillment location; and
evaluating a purchase history of the first customer and confirm that the purchase history has a predefined purchase history threshold relationship with a purchase history restriction of the first print campaign.

14. The method of claim 12, further comprising:
confirming a second print campaign, of the multiple different print campaigns, has a secondary predefined campaign threshold relationship with at least one of the first customer and the at least one item; and
establishing the first print plan dependent on the first package fabrication pattern and incorporating both the first print campaign and the second print campaign.

15. The method of claim 11, wherein the identifying the first fulfillment facility comprises:
identifying a second fulfillment facility, of the multiple different fulfillment facilities, is a priority fulfillment location of the first customer order;
identifying that the second fulfillment facility is incapable of providing custom printing; and
selecting the first fulfillment facility as a substitute fulfillment facility over the second fulfillment facility based on the first fulfillment facility having the custom printing system, the fulfillment location and the first fulfillment facility having the at least one item.

16. The method of claim 11, wherein the identifying the first fulfillment facility comprises:
identifying a fulfillment location of the first customer order;
confirming that the first fulfillment facility and a second fulfillment facility each has a location threshold relationship with the fulfillment location;
confirming that each of the first fulfillment facility and the second fulfillment facility is a predicted to have the at least one item at an estimated time of fulfillment;
identifying a cost benefit of fulfilling the first customer order through the first fulfillment facility over fulfillment at the second fulfillment facility; and
selecting the first fulfillment facility, based on the identified cost benefit, to fulfill at least part of the first customer order comprising the at least one item.

17. The method of claim 10, wherein the confirming that the first customer order is eligible to include the custom package printing comprises:
identifying that the first customer is associated with a customer level authorizing the first customer to elect to add customized printing; and
controlling a customer user interface to present an option to the first customer of authorizing the customized printing.

18. The method of claim 10, wherein the confirming that the first customer order is eligible to include the custom package printing comprises:
evaluating multiple different print campaigns in relation to the first customer;
identifying that a first print campaign and a second print campaign, of the multiple different print campaigns, each has a respective predefined campaign threshold relationship with at least one of the first customer and the at least one item;
identifying that the first print campaign has a priority over the second print campaign; and
establishing, based on the priority of the first print campaign, the first print plan in accordance with the first print campaign and the first package fabrication pattern.
